(19) United States
(12) Patent Application Publication
(10) Pub. No.: US 2012/0213036 A1
(43) Pub. Date: Aug. 23, 2012

(54) Electroacoustic Transducer, in Particular Transmitting Transducer

(75) Inventor: Rainer Busch, Oldenburg (DE)

(73) Assignee: Atlas Elektronik GmbH, Bremen (DE)

(21) Appl. No.: 13/496,099

(22) PCT Filed: Sep. 22, 2009
(86) PCT No.: PCT/DE2009/001333

§ 371 Date: May 3, 2012

(51) Int. Cl. H04R 17/00

(52) U.S. Cl. 367/157

(57) ABSTRACT

An electroacoustic transducer, in particular a transmitting transducer for sonar systems, is disclosed, comprising two end caps that are arranged at a fixed distance from each other, multiple bars which are braced between the two end caps and the ends of which are attached to the end caps next to each other in the peripheral direction, and an elastic shell that externally encloses the bars. In order to significantly reduce the weight of the transducer and simplify production, composite modules are attached to the bars so as to excite vibrations. Each composite module has electrode structures that include spaced-apart electrodes and are arranged on at least two film layers made of insulating material, and spaced-apart piezoceramic fibers which are arranged between the film layers and are contacted by the electrodes on opposite longitudinal sides.

The invention relates to an electroacoustic transducer, in particular a transmitting transducer, according to the precharacterizing clause of claim 1.

In a known electroacoustic transducer, which is referred to as “Barrel Stave Projector”, for use in low-frequency sonar systems (U.S. Pat. No. 6,535,459 B1), the distance between the two end caps, which are in the form of plates, is produced by a piezoelectric actuator, which consists of a stack of hollow-cylindrical, piezoceramic elements with electrodes arranged between them. The two annular or polygonal end caps, which are like plates, are arranged on the end faces of the stack, and a tie rod, which is passed through the hollow-cylindrical piezoceramic elements and the end plates applies mechanical pressure to the stack. The concave-curved laminates which are stretched between the end caps are attached by their ends to the circumference of the end caps, separated by a gap when seen in the circumferential direction, alongside one another. The concave-curved laminates are surrounded on the outside on their side facing away from the stack by a rubber casing, which is attached in a watertight manner to the end caps and covers the gaps between the laminates in a watertight manner. An electroacoustic transducer such as this, which is used as a transmitting transducer, transmits a relatively narrow bandwidth and can be used only as far as a specific water depth, for example about 100 m, with its transmission behaviour being influenced by the water depth, because it is filled with air.

The stack of piezoelectric elements, the so-called piezostack, and the clamping apparatus for this are relatively heavy in the case of the known electroacoustic transducer, which makes it unattractive for certain types of use in underwater sound technology, for example for installation in towed antennas or towed bodies.

The invention is based on the object of specifying an electroacoustic transducer which is particularly suitable for underwater use, is distinguished by a low weight and can be manufactured cost-effectively, while having a sufficiently high acoustic power, in particular transmitted power.

According to the invention, the object is achieved by the features of claim 1.

The electroacoustic transducer according to the invention has the advantage that the laminates are not excited to oscillate by a heavyweight stack of piezoelectric elements which, in addition, also has to be mechanically prestressed by a robust and heavy tie rod, but rather by thin and lightweight composite modules, which are attached directly to the laminates. The composite modules are attached to the laminates, which are preferably produced from plastic, while preferably laminating them on or in during the laminate production, thus protecting the composite modules, which are not resistant to fluids, against environmental influences, such as water or oil in a manner which is simple from the manufacturing point of view, even at this stage. Instead of being laminated in or on, adhesive bonding with a suitable adhesive is also feasible. The transducer is distinguished by a wider bandwidth than the known Bare! Stave transducers and, because of its low weight and its dimensions which can easily be adapted, is very highly suitable for use in acoustic underwater towed antennas.

Expedient embodiments of the electroacoustic transducer according to the invention, together with advantageous developments and refinements of the invention, are specified in the further claims.

According to one advantageous embodiment of the invention, each composite module is aligned on the laminates such that the piezoceramic fibres run in the longitudinal direction of the laminates. The electrodes have a DC voltage applied to them such that a high and a low DC voltage potential are present alternately on the electrodes which are alongside one another on a film layer and the same potential is in each case present on the electrodes which are opposite one another on the piezoceramic fibres on the two film layers. An AC voltage can be applied to the electrodes in order to excite oscillation of the laminates. When the AC voltage is applied, the piezoceramic fibres in the composite modules expand and contract in the same sense in the longitudinal direction of the laminates, as a result of which the laminates are curved to a greater or lesser extent, because they are mechanically fixed at one end, and therefore oscillate transversely with respect to the transducer axis, that is to say in the radial direction, and produce sound waves in the surrounding medium. The acoustic power of the electroacoustic transducer can be adjusted by the choice of the moduli of elasticity of the laminates and the number of composite modules in each laminate.

According to one advantageous embodiment of the invention, the distance between the end plates is produced by means of a tube to whose two end faces the end plates are attached such that they project radially beyond the tube. The tube is preferably composed of a plastic material with carbon or glass fibres incorporated. If the end plates and the laminates are advantageously also produced from the plastic material, then the entire transducer can be manufactured completely from GRP material, cost-effectively. A transducer such as this is robust and is light in weight.

According to one advantageous embodiment of the invention, each end cap has a through-opening which is preferably coaxial with the tube axis, in its area bounded by the end face of the tube, and the tube envelope of the tube has apertures. The end caps are supported over their circumference in the interior of a flexible tube, which is filled with oil or gel, of an underwater towed antenna on the flexible-tube wall thereof and the intermediate space which is enclosed by the flexible-tube wall on the one hand and the casing which covers the laminates on the other hand is hermetically sealed and is filled with the same oil or gel. These design measures advantageously allow a transmitting part, which is also included in the flexible tube of the towed antenna and comprises a plurality of transducers of the described type arranged one behind the other in the longitudinal direction of the flexible tube, to be provided in an underwater towed antenna. The hollow interior of the transducers advantageously allows the towing cable of the underwater towed antenna, which runs in the flexible tube, and the connecting lines for the transducers, which are provided in the flexible tube, and an electronic module to be passed out centrally through the interior of the transducers. The hermetic sealing of the oil-filled or gel-filled intermediate space which extends between the end caps and is enclosed by the flexible-tube wall and the casing prevents an acoustic short between the plurality of transducers in the transmitting part.

According to one advantageous embodiment of the invention, the tube wall of the tube to which the end plates are attached is fitted with a plurality of composite modules fitted to it, which are at a distance from one another in the circumferential and axial direction of the tube and are firmly connected to the tube wall, preferably being laminated into the tube wall. These composite modules are operated in the same manner as the composite modules associated with the laminates. Operation results in the tube being alternately expanded and contracted on the longitudinal axis, amplifying the compression and expansion of the laminates produced by the composite modules in the laminates, as a result of which the acoustic power emitted from the transducer is increased. As in the case of the laminates, the composite modules can be arranged on the inside or outside, or on the inside and outside, and then preferably alternatively, of the tube wall, and are preferably laminated into the tube wall, such that they are protected against the surrounding medium of the tube, such as oil or gel.

The invention will be described in more detail in the following text with reference to exemplary embodiments which are illustrated in the drawings, in which, illustrated schematically:

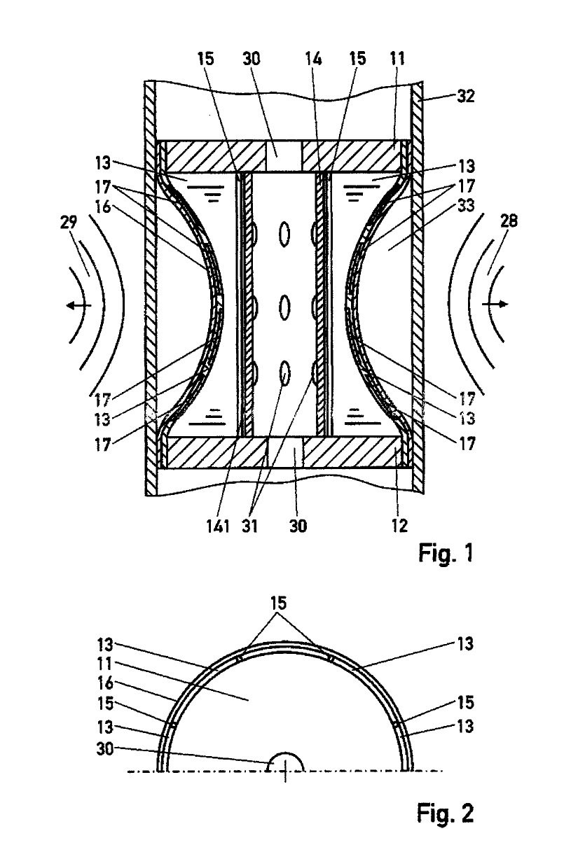

FIG. 1 shows a longitudinal section through an electroacoustic transducer, inserted into a flexible tube of an underwater towed antenna,

FIG. 2 shows a detail of a plan view of the electroacoustic transducer shown in FIG. 1,

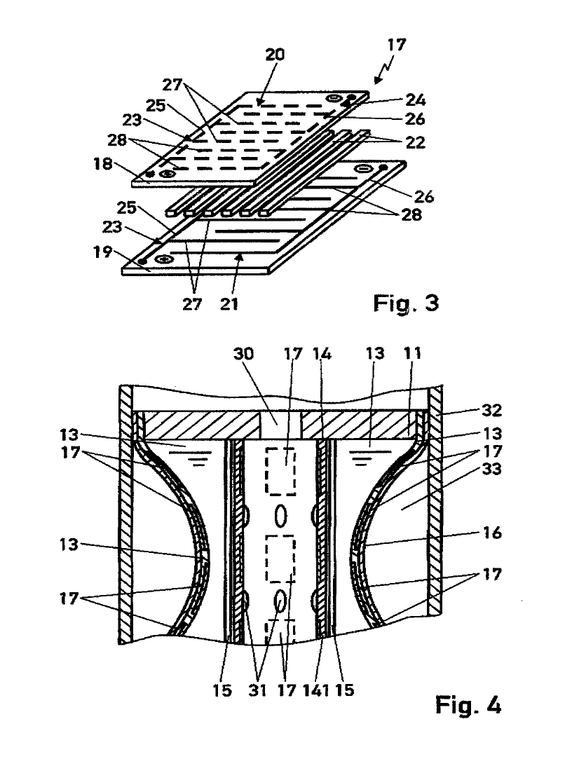

FIG. 3 shows an enlarged exploded illustration of a composite module in the electroacoustic transducer in FIGS. 1 and 2, and

FIG. 4 shows a detail of a longitudinal section through an electroacoustic transducer, modified from the transducer illustrated in FIG. 1.

The electroacoustic transducer, which is illustrated in the form of a detail of a plan view in FIG. 2 and in the form of a longitudinal section in FIG. 1, and which is preferably operated as a transmitting transducer, has two end caps 11, 12 which are arranged at a distance from one another, for example end caps 11, 12 like plates, and laminates 13 which can oscillate, in this case have concave curvature, and are stretched between the two end caps 11, 12. The two end caps 11, 12 are attached to the end face of a tube 14 such that they project radially beyond the tube 14. By way of example, the tube 14 is composed of plastic with carbon or glass fibres incorporated. The end caps 11, 12 and the laminates 13 are preferably produced from the same plastic material, as a result of which the entire transducer can be manufactured completely from plastic, in a cost-effective manner. In the exemplary embodiments, the end caps 11, 12 are in the form of circular plates. Along their circumference, the laminates 13 are arranged alongside one another with gaps 15 remaining between them, and their ends are attached to the end caps 11, 12. However, the end caps 11, 12 may also be in the form of polygonal plates, whose number of edges corresponds to the number of laminates 13, where the laminate ends each rest on a flat surface of the end caps 11, 12, which extends between the edges, and are attached to this surface. The laminates 13 which are arranged alongside one another and surround the tube 14 are surrounded on the outside, that is to say on their outside facing away from the tube 14, by a fluid-tight, elastic casing 16, which covers the gaps 15 between the laminates 13 in a liquid-tight manner. The casing 16 is attached to the end caps 11, 12 at the ends, in a fluid-tight manner.

In order to excite oscillation of the laminates 13 which are stretched between the end caps 11, 12, at least one composite module 17 is fixed to each laminate 13. A plurality of composite modules are preferably arranged on each laminate 13, with the composite modules 17 being arranged at a distance from one another in the longitudinal direction of the laminates 13. The composite modules 17 are firmly connected to the laminates 13, for example by adhesive bonding or laminating on the composite modules, with the composite modules 17 being arranged on the outside or inside, or on the outside and inside, of the laminates 13. In the exemplary embodiment, the composite modules 17 are arranged alternately on the inside and outside of the laminates 13, on each laminate 13, and are laminated into the laminate 13, and this is done during the process of producing the laminates 13.

FIG. 3 shows an enlarged exploded illustration of the construction of a composite module 17, in schematic form as a sketch. The composite module 17 has two coincident film layers 18, 19 composed of electrically insulating material, on each of whose mutually facing layer surfaces a respective electrode structure 20 or 21 is arranged, for example by printing. In order to visualize the electrode structure 20 which is arranged on the lower layer surface of the upper film layer 18 in FIG. 3, this is shown by dashed lines. Piezoceramic fibres 22 are arranged between the film layers 18, 19, which piezoceramic fibres 22 are arranged at a distance from one another and are preferably aligned parallel to one another. The elongated piezoceramic fibres 22 have, for example, a square or rectangular cross section. The intermediate spaces between the piezoceramic fibres 22 are filled with an electrically insulating material, for example with a polymer or epoxy, although this is not illustrated in FIG. 3 for the sake of clarity, thus resulting in a cohesive composite layer. The two electrode structures 20 are identical. Each electrode structure 20 or 21 has two identical, comb-like structure parts 23, 24 with a respective conductor track 25 or 26, which extends in the direction of the piezoceramic fibres 22, and finger-like electrodes 27, 28 which project integrally therefrom and are preferably aligned parallel to one another. The electrodes 27, 28 on the two comb-like structure parts 23, 24 engage in one another, as a result of which one electrode 27 of one structure part 23 and one electrode 28 of the other structure part 24 of the respective electrode structures 20 and 21 are in each case adjacent, and run parallel to one another. Electrodes 27, 28 arranged in this way are therefore also referred to as “interdigitated electrodes”. The two film layers 18, 19 are applied to the piezoceramic fibres 22 in mirror-image form with mutually facing electrode structures 20, 21, in which case only the electrodes 27, 28 (and not the conductor tracks 25, 26) make contact with the piezoceramic fibres 22 on their longitudinal sides, which face away from one another. The two film layers 18, 19 with electrode structures 20, 21 resting on the piezoceramic fibres 22 are firmly connected to one another. A composite module 17 such as this is known and is described, for example, in EP 1 983 584 A2, where it is referred to as a “Piezoelectric macro-fiber composite actuator”. The composite modules 17 which are connected to the laminates 13 are aligned on the laminates 13 such that the piezoceramic fibres 22 run in the longitudinal direction of the laminates 13. As is shown in FIG. 3, the two structure parts 23, 24 of each electrode structure 20, 21 have a DC voltage applied to them, as a result of which a high and a low DC voltage potential are produced alternately on the electrodes 27, 28 which are located alongside one another on a respective film layer 18 or 19, and the same DC voltage potential is in each case produced on the respective electrodes 26 and 27, which are opposite one another on the piezoceramic fibres 22, of the two film layers 18, 19. An AC voltage is superimposed on the DC voltage, such that the latter is not undershot. The applied AC voltage results in the piezoceramic fibres 22 carrying out longitudinal expansions and longitudinal contractions in the same sense in all the composite modules 17, as a result of which the radius of curvature of the concave laminates 13 is alternately increased and decreased, and the laminates 13 therefore “breath” in the radial direction. In consequence, the electroacoustic transducer emits sound waves 29 in the radial direction, as is illustrated symbolically in FIG. 1. Because of the small dimensions of the transducer in comparison to the wavelengths of the sound waves emitted by it at an operating frequency of, for example, 2 kHz, the transducer has an omnidirectional emission behaviour with broadband sound emissions. Further film layers of the same type likewise with such electrode structures 20, 21, can rest on the two film layers 18, 19, in which case there is always one layer of piezoceramic fibres 22 between two respective film layers in the described arrangement.

For use in underwater towed antennas, the end caps 11, 12, which are then preferably circular, are provided in their area bounded by the end face of the tube 14 with a through-opening 30, which is preferably in the form of a coaxial hole, and the tube 14 is provided in its tube envelope 141 with apertures 31, for example in the form of slots, or circular or elliptical holes. The electroacoustic transducer is inserted into a flexible tube 32 of an underwater towed antenna such that the end caps 11, 12 are supported over their circumference on the flexible-tube wall of the flexible tube 32. This is illustrated for one electroacoustic transducer in FIG. 1. In order to form the acoustic transmitting part of an underwater towed antenna, a plurality of such electroacoustic transducers are arranged one behind the other in the described manner in the flexible tube. A towing cable, which normally runs centrally in the flexible tube 32 but is not illustrated here, of the underwater towed antenna is passed through the hollow interior of the transducers, surrounded by the tube 14, in the same way as the electrical connecting lines for the transducers. The flexible tube 32 is filled with oil or gel and is closed at the ends. The intermediate space 33, which for each transducer extends between the two end caps 11, 12 and is bounded by the flexible-tube wall of the flexible tube 32 and the casing 16 which surrounds the laminates 13, is hermetically sealed and is filled with the same oil or gel as the rest of the flexible tube 32. This ensures that no acoustic short can occur between transducers which are arranged one behind the other in the flexible tube 32.

The electroacoustic transducer illustrated in the form of a detail longitudinal section in FIG. 4 has been modified in comparison to the electroacoustic transducer illustrated in FIG. 1 and described above to the extent that composite modules 17 of the type described above are also associated with the tube 14, and are firmly connected to the tube wall 141 in the circumferential and axial direction of the tube 14. The composite module 17 and the tube wall 141 are preferably firmly connected by laminating on or laminating in, but this can also be done by adhesive bonding using a suitable adhesive. In the exemplary embodiment shown in FIG. 4, the composite modules 17 are laminated in on the inside of the tube wall 141. However, they can also be arranged on the outside of the tube wall 141 or on the inside and outside of the tube wall 141, and also lie, as is illustrated for the laminates 13 in FIG. 1, alternately on the inside and outside of the tube wall 141. The composite modules 17 associated with the tube 14 and the laminates 13 are operated in the same way. In addition to the expansion and contraction of the laminates 13, which are fixed to the ends, as already described with reference to FIG. 1, which leads to a change in the outward bulging of the laminates 13, the tube 14 is also stretched and shortened, thus amplifying the effect of varying the curvature of the laminates 13, the laminates 13 oscillate with a greater amplitude in the radial direction, and the transducer emits a greater acoustic power.

As a modification to the described exemplary embodiments, the laminates 13 may also have convex curvature. However, the transducer is then less suitable for installation in the flexible tube of an underwater towed antenna, but can always be used for other purposes. It is also possible for the laminates 13 not to be curved, and for the laminates 13 to be designed such that they are stretched flat. The effect of converting the stretching movement of the laminates 17 to a radial outward bulging movement is, however, reduced, as a result of which the acoustic power of the transducer falls.

All of the features mentioned in the above description and in the claims can be used according to the invention, both individually and in any desired combination. The invention is therefore not restricted to the described and claimed feature combinations. In fact, all combinations of individual features are considered to have been disclosed.

1. Electroacoustic transducer, in particular a transmitting transducer for sonar systems, having two end caps (11, 12) which are arranged at a distance from one another and have a plurality of laminates (13) in particular concave-curved laminates (13) which are stretched between the end caps (11, 12) and which are fixed at the end on the end caps (11, 12) alongside one another in the circumferential direction and can be excited to oscillate, and having an elastic casing (16) which surrounds the laminates (13) on the outside,
wherein
at least one composite module (17) is fixed to each laminate (13) in order to excite oscillations and has electrode structures (20, 21), which are arranged on at least two film layers (18, 19) composed of insulating material and have preferably parallel electrodes (27, 28), which are at a distance from one another, and preferably parallel piezoceramic fibres (22) which are arranged between the film layers (18, 19), are at a distance from one another and make contact with electrodes (27, 28) on their longitudinal sides which face away from one another.

2. Electroacoustic transducer according to claim 1,
wherein
the at least one composite module (17) is aligned on the laminate (13) such that the piezoceramic fibres (22) run in the longitudinal direction of the laminates (13), and that the electrodes (27, 28) have a DC voltage applied to them such that a high and a low DC voltage potential are present alternately on the electrodes (27, 28) which are alongside one another on a film layer (18 and 19, respectively) and the same DC voltage potential is in each case present on the electrodes (27 and 28, respectively) which are opposite one another on the piezoceramic fibres (22) on the two film layers (18, 19), and such that an AC voltage can be applied to the electrodes (27, 28).

3. Electroacoustic transducer according to claim 1,
wherein
the composite modules (17) are fixed to the laminates by laminating them in or on.

4. Electroacoustic transducer according to claim 1,
wherein
each laminate (13) has a plurality of composite modules (17) fitted to it, which are arranged at a distance from one another in the longitudinal direction of the laminates (13).

5. Electroacoustic transducer according to claim 4,
wherein
the plurality of composite modules (17) are arranged such that they follow one another on the outer or inner sides, or alternately on sides which face away from another, of the laminates (13).

6. Electroacoustic transducer according to claim 1,
wherein
the laminates (13) are composed of plastic material with glass or carbon fibres incorporated.

7. Electroacoustic transducer according to claim 1,
wherein
the distance between the end caps (11, 12) is produced by means of a tube (14) which is preferably composed of plastic with carbon or glass fibres incorporated, and to whose two end faces the end caps (11, 12), which are preferably composed of plastic, are attached such that they project radially beyond the tube (14).

8. Electroacoustic transducer according to claim 7,
wherein
each end cap (11, 12) has a through-opening (30) which is preferably coaxial with the tube axis, in its area bounded by the end face of the tube (14), and the tube wall (141) of the tube (14) has apertures (31).

9. Electroacoustic transducer according to claim 8,
wherein
the end caps (11, 12) are supported over their circumference in the interior of a flexible tube (32), which is filled with oil or gel, of an underwater towed antenna on the flexible-tube wall thereof, and in that the intermediate space (33), which extends between the two end caps (11, 12) and is bounded by the flexible-tube wall and the casing (16) which covers the laminates, is hermetically sealed and is filled with the same oil or gel.

10. Electroacoustic transducer according to claim 7,
wherein
the tube wall (141) of the tube (14) is fitted with a plurality of composite modules (17) which are at a distance from one another in the circumferential and axial direction of the tube (14) and are firmly connected to the tube wall (141), preferably being laminated into the tube wall (141).

11. Electroacoustic transducer according to claim 10,
wherein
the composite modules (17) are arranged on the outside or inside of the tube wall (141) or on the outside and inside of the tube wall, or preferably alternately on the outside and inside of the tube wall (141).
